(19) United States
(12) Patent Application Publication
(10) Pub. No.: US 2026/0202949 A1
(43) Pub. Date: Jul. 16, 2026

(54) SYSTEMS, APPARATUSES, METHODS, AND NON-TRANSITORY COMPUTER-READABLE STORAGE MEDIA FOR SUPPORTING MULTIPLE INTERACTIONS WITH A USER DEVICE

(71) Applicant: HUAWEI TECHNOLOGIES CO., LTD., Shenzhen (CN)

(72) Inventors: Yu Zhao, Richmond Hill (CA); Yuan Deng, Markham (CA); Che Yan, Scarborough (CA); Soumil Chugh, Toronto (CA); Gwan Kei Abby Lui, Scarborough (CA); Wei Li, Richmond Hill (CA); Yixuan Yang, Wuhan (CN)

(21) Appl. No.: 19/210,598

(22) Filed: May 16, 2025

Related U.S. Application Data
(63) Continuation-in-part of application No. 19/025,409, filed on Jan. 16, 2025.

(51) Int. Cl. G06F 3/04842; G06F 3/0482; G06F 3/04883; G06F 3/16

(52) U.S. Cl. CPC G06F 3/04842; G06F 3/0482; G06F 3/04883; G06F 3/167

(57) ABSTRACT

Systems, apparatuses, methods, and computer-readable storage media are disclosed for supporting multiple user interactions associated with content on a user interface of a user device. A computerized method comprises: determining, by a user device, that a triggering user interaction has occurred; triggering a multi-operation input mode for a user to interact with content on a user interface; receiving, during the input mode, multiple user interactions associated with the content on the user interface; determining that the multiple user interactions associated with the content are completed, and exiting the multi-operation input mode; and based on the multiple user interactions during the input mode, performing an executable process and generating an output for display in the user interface.

### CROSS-REFERENCE TO RELATED APPLICATION

This application is a continuation-in-part of U.S. patent application Ser. No. 19/025,409, filed on Jan. 16, 2025, the entire contents of which is hereby incorporated by reference for all purposes.

### FIELD OF THE DISCLOSURE

The present disclosure relates generally to systems, apparatuses, methods, and non-transitory computer-readable storage media for supporting multiple interactions with a user device, and in particular to systems, apparatuses, methods, and non-transitory computer-readable storage media for supporting multiple user interactions associated with content on a user interface of a user device.

### BACKGROUND

The widespread use of digital pens (also referred to as styluses) on touchscreens has drastically changed how people interact with technology, providing greater accuracy and flexibility for navigating and creating content.

Pen interactions for common tasks on touch screen devices usually can be switched between continuous strokes (ink input) and single touch point (pen-tip touch) depending on the use case (i.e. “mode-switch”). Pre-set gestures can provide an efficient way to manipulate text in a writing application without changing a user's grip style or utilizing a keyboard. On the other hand, during navigation and browsing, the interaction of the pen is equivalent to a finger. To select text, the pen or finger will touch and dwell on the target. When a handle appears, the user may drag the handle to adjust the area of selection.

There are several solutions available in existing products to solve the mode-switch problem (switching between continuous ink input and single pen-tip touch across different scenarios). However, there are two main limitations to these pen interaction methods for mode switch. First, the function that pen-drawing triggers is usually preset. Second, current solutions only support a single pen stroke rather than multiple-strokes, and only supports predefined pen strokes, such as a circle, line, or scribble. Single and predefined pen strokes limits the ability for users to interact with content.

Accordingly, systems, apparatuses, methods, and computer-readable storage media for supporting multiple interactions with content on a user interface of a user device remain highly desirable.

### SUMMARY

According to one aspect of this disclosure, there is provided a computerized method, comprising: determining, by a user device, that a triggering user interaction has occurred; triggering a multi-operation input mode for a user to interact with content on a user interface; receiving, during the input mode, multiple user interactions associated with the content on the user interface; determining that the multiple user interactions associated with the content are completed, and exiting the multi-operation input mode; and based on the multiple user interactions during the input mode, performing an executable process and generating an output for display in the user interface.

In some embodiments, the executable process performed is not a predetermined result of the multiple user interactions.

In some embodiments, performing the executable process comprises: generating a prompt to an artificial intelligence model based on the multiple user interactions; providing the prompt to the artificial intelligence model; and receiving the output from the artificial intelligence model.

In some embodiments, generating the prompt comprises determining, based on the multiple user interactions, an object of the content that the user has interacted with, and a task to be executed.

In some embodiments, determining the object of the content that the user has interacted with comprises performing intention-based object selection. In some embodiments, performing intention-based object selection comprises analyzing the multiple user interactions to define an initial selection; and modifying the initial selection to a semantically complete object. Accordingly, this selection may involve analyzing user pen gestures (e.g., circles, lines, scribbles) to define an initial selection scope, and then expanding or reducing this scope to identify a semantically complete object as intended by the user.

In some embodiments, modifying the initial selection comprises at least one of: adjusting a start boundary of the initial selection to an adjusted start boundary of an adjusted selection, wherein the adjusted start boundary is a valid semantic start; and adjusting an end boundary of the initial selection to an adjusted end boundary of the adjusted selection, wherein the adjusted end boundary is a valid semantic end; and wherein the adjusted selection defined by the adjusted start boundary and/or the adjusted end boundary is semantically complete. Accordingly, in some embodiments, expanding or reducing the initial selection scope to find the semantically complete object involves adjusting the start and/or end boundaries of the initial selection. For expansion, the start is extended to the nearest valid semantic start (e.g., start of a sentence/phrase) and the end is extended to the nearest valid semantic end. For reduction, the start is trimmed to the farthest valid semantic start and the end is trimmed to the farthest valid semantic end, all while maintaining semantic completeness.

In some embodiments, the adjusted selection is determined by: calculating an editing cost for each of one or more potential adjusted selections based on the number of sematic objects added or removed; and measuring a gesture alignment score for each of the one or more potential adjusted selections based on a spatial overlap between a gesture bounding box and an adjusted selection bounding box; wherein the adjusted selection is one of the of one or more potential selections with a lowest editing cost and a highest gesture alignment score. Accordingly, the decision to expand or reduce the start and end boundaries of the initial selection may be made as follows: calculating an editing cost for each expansion or reduction scenario, determined by the number of words, sentences, or paragraphs added or removed; measuring a gesture alignment score for each scenario based on the spatial overlap between the user's pen gesture (gesture bounding box) and the adjusted text (selection bounding box); and recommend the scenario with the lowest editing cost and highest gesture alignment score to the user. Optionally, the user may manually adjust the selection's start and end scope.

In some embodiments, the multiple user interactions associated with the content comprise one or more types of user interactions selected from: a gesture made on the user interface, a text annotation on the user interface, a symbol drawn on the user interface, and user voice input.

In some embodiments, the multiple user interactions comprise one or more of: the gesture made on the user interface followed by the text annotation; the gesture made on the user interface followed by the user voice input; and the gesture made on the user interface followed by the symbol drawn on the user interface.

In some embodiments, the method further comprises one or more of: performing optical character recognition on the text annotation to determine text written on the user interface, wherein the text written on the user interface is the task to be executed; performing automatic speech recognition on the user voice input to determine text corresponding to the user voice input, wherein the text corresponding to the user voice input is the task to be executed; and determining a predefined function associated with the symbol drawn on the user interface, wherein the predefined function is the task to be executed.

In some embodiments, the method further comprises: receiving, after the multiple user interactions associated with the content are completed, a further user interaction to prompt the artificial intelligence model; and generating the prompt in response to the further user interaction.

In some embodiments, the output generated for display in the user interface further comprises an input interface for a user to input a further inquiry for prompting the artificial intelligence model. In some embodiments, generating the output comprises: determining, based on the multiple user interactions, an object of the content that the user has interacted with; and generating the output as an option menu associated with the object.

In some embodiments, determining that the multiple user interactions associated with the content are completed comprises: initiating a timer when the input mode is triggered; refreshing the timer when a user interaction associated with the content is received; and determining that the multiple user interactions associated with the content are completed when the timer expires.

In some embodiments, the method further comprises: determining presence of an indicator that the user has completed interactions with the content; and reducing a duration of the timer based on the presence of the indicator.

In some embodiments, reducing the duration of the timer comprises causing expiry of the timer based on the presence of the indicator.

In some embodiments, the indicator that the user has completed interactions with the content comprises one or more of: a digital stylus used to interact with the content is in a stationary state; text annotations written on the user interface are semantically complete; a tip of the digital stylus exits a hover state above the user interface; a touch area and/or pressure applied to the user interface disappears; and a pressure applied to a body of the digital stylus reduces beyond a threshold between a writing state and a current state.

In some embodiments, the multiple user interactions associated with the content comprise a user interaction using a digital stylus.

In some embodiments, the triggering user interaction with the user device is one of: applying pressure to a tip of a digital stylus against the user interface; performing a corner swipe on the user interface; hovering the digital stylus above the user interface followed by tapping the tip of the digital stylus against the user interface; touching the user interface with the tip of the digital stylus and a user finger simultaneously; and applying pressure to a body of the digital stylus.

According to one aspect of this disclosure, there is provided one or more processors functionally connected to one or more memories storing instructions, the one or more processors are configured to execute the instructions to perform the above-described method.

According to one aspect of this disclosure, there is provided an apparatus comprising one or more processors functionally connected to one or more memories storing instructions; the one or more processors are configured to execute the instructions to perform the above-described method.

According to one aspect of this disclosure, there is provided one or more memories storing instructions; the instructions, when executed, cause one or more processors to perform the above-described method.

In another aspect, embodiments of this disclosure provide an apparatus, wherein the apparatus comprises a function or unit to perform any of the methods disclosed herein.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configured to perform any of the methods disclosed herein.

According to one aspect of this disclosure, there is provided a module comprising: one or more circuits for performing the above-described method.

According to one aspect of this disclosure, there is provided one or more processors functionally connected to one or more memories for performing the above-described method.

According to one aspect of this disclosure, there is provided an apparatus comprising: one or more processors functionally connected to one or more memories for performing the above-described method.

According to one aspect of this disclosure, there is provided an apparatus configured to perform the above-described method.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform the above-described method.

According to one aspect of this disclosure, there is provided one or more computer-readable storage media storing a computer program, wherein, when the computer program is executed by an apparatus, the apparatus is enabled to implement the above-described method.

According to one aspect of this disclosure, there is provided a computer program product including one or more instructions, wherein, when the instructions are executed by an apparatus, the apparatus is enabled to implement the above-described method.

According to one aspect of this disclosure, there is provided a computer program, wherein, when the computer program is executed by a computer, an apparatus is enabled to implement the above-described method.

According to one aspect of this disclosure, there is provided a system comprising a node for performing the above-described method.

According to one aspect of this disclosure, there is provided an apparatus for implementing the method in any possible implementation of the foregoing aspects.

In various embodiments, the systems, apparatuses, methods, and computer-readable storage media disclosed herein provide several advantages and benefits.

For example, in some embodiments, the systems, apparatuses, methods, and computer-readable storage media disclosed herein enable multimodal and multiple user inputs/interactions with content, including multiple types of interactions using a writing instrument such as a pen or digital stylus for example, in non-writing scenarios (e.g. web browsing, file reading, etc.), and can execute non-preset and complex inquiries.

In some embodiments, the systems, apparatuses, methods, and computer-readable storage media disclosed herein provide a solution to identify multiple user inputs/interactions as one coherent task, and then to initiate a single inquiry for generating an output smoothly. Accordingly, users can continuously draw, write, and/or speak as one coherent task, the multiple user inputs/interactions are analyzed to determine a single inquiry based on the multiple user inputs/interactions, which is then initiated/executed. Triggering a multiple operations mode input mode can be implemented as a system level flow.

In some embodiments, the systems, apparatuses, methods, and computer-readable storage media disclosed herein can: (1) determine when to trigger an input mode that supports multiple user interactions with content; (2) determine when the multiple user interactions are completed as one coherent task, exit the input mode, and trigger an inquiry (i.e. task execution) process in response to the multiple user interactions; (3) determine how to integrate the multiple user interactions into a single inquiry by analyzing a sequence of the multiple inputs corresponding to the multiple user interactions with the content; and (4) generate an appropriate output in response to the single inquiry, for example by prompting an AI model with the inquiry for execution of the task defined by the multiple user interactions.

In some embodiments, a dynamic timer is used to determine the completion of all operations. The dynamic timer can identify the completion of writing/speaking naturally based on contextual information (e.g. semantically complete text annotations) and/or features of the user device(s) (e.g. pen posture, touch area on screen, pressure on pen body, etc.), so that no extra steps are needed to proactively stop the input mode.

In some embodiments, the multiple user interactions are used to generate LLM-suitable commands, so that all sequence-based multiple operations are integrated into a single inquiry/prompt, allowing users to ask any kind of complexed inquiries, without being limited to preset function(s).

In some embodiments, a dedicated pen/hand gesture can be performed during the input mode to proactively trigger an AI agent (i.e. AI functionality). In some embodiments, if the user chooses to do nothing, a conventional popup menu could be presented (for conventional operations, such as copy, search, translate etc.). Accordingly, users can choose to stay with conventional menu-based interaction or to involve AI agent for further inquiry, which provides additional user flexibility.

The systems, apparatuses, methods, and computer-readable storage media disclosed herein thus advantageously facilitate an improved user experience when interacting with content on a user interface of a user device in a non-writing mode, and support more options for users to interact with the content compared to pre-set and/or single pen strokes, in particular by allowing users to provide multiple inputs and multi-modal types of inputs as they interact with content.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

According to one aspect of this disclosure, there is provided a system comprising a node for performing any of the methods disclosed herein.

### BRIEF DESCRIPTION OF THE DRAWINGS

For a more complete understanding of the disclosure, reference is made to the following description and accompanying drawings, in which:

FIG. 1 is a schematic diagram of a computer network system, according to some embodiments of this disclosure;

FIG. 2 is a schematic diagram showing a simplified hardware structure of a computing device of the computer network system shown in FIG. 1;

FIG. 3 is a schematic diagram showing a simplified software architecture of a computing device of the computer network system shown in FIG. 1;

FIG. 4 is a schematic diagram showing an artificial intelligence (AI) engine, wherein the AI engine comprises a large language model (LLM);

FIG. 5 is a method for supporting multiple user interactions associated with content on a user interface;

FIG. 6 is a further method for supporting multiple user interactions associated with content on a user interface;

FIGS. 7A-D are examples of user interactions used to trigger an input mode;

FIGS. 8A and 8B are example methods of determining that multiple user interactions associated with the content are completed;

FIG. 9 shows representations of examples of indicators that the user has completed the multiple user interactions;

FIG. 10 shows a representation of an example of how a user can exit the input mode;

FIG. 11 is a method of generating a prompt to an artificial intelligence model based on multiple user interactions;

FIG. 12 shows a representation of multiple user interactions associated with the content and a corresponding output;

FIG. 13 is a further method of generating a prompt to an artificial intelligence model based on multiple user interactions;

FIG. 14 shows a representation of multiple user interactions associated with the content and a corresponding output;

FIG. 15 is a further method of generating prompt to an artificial intelligence model based on multiple user interactions;

FIG. 16 shows a representation of multiple user interactions associated with the content and a corresponding output;

FIG. 17 is a method of performing intention-based object selection;

FIGS. 18A-D show examples of intention-based object selection;

FIGS. 19A and 19B show two example representations of triggering an AI agent; and

FIG. 20 shows a representation of different possible flows for generating an output based on whether an AI trigger gesture is input.

### DETAILED DESCRIPTION

Embodiments disclosed herein relate to systems and apparatuses for supporting multiple user interactions with content on a user device. The systems and apparatuses disclosed herein comprise a digital device (e.g. a main device) that can support user interaction thereon, such as a tablet, touch screen, personal computer, smart phone, smart watch, smart glasses, a hybrid device, etc. In embodiments disclosed herein, the user interaction can be performed via various input devices. In some embodiments, the input device may comprise a writing instrument such as a digital stylus (pen), a finger or the like. In some embodiments, the input device may also comprise a microphone for supporting user interaction via a user's voice (i.e. audio input).

In accordance with embodiments of the present disclosure, the digital stylus should support both continuous ink printing and pen-tip interaction with the main digital device. As will be described in more detail below, a pen or digital pen is a stylus designed to mimic the feel and functionality of a traditional pen for writing and drawing on touchscreens. The functionalities of a pen could also extend beyond basic styluses, such as pressure sensitivity and buttons for additional controls. As will be described in more detail below, a pen gesture refers to specific movements or actions made with a stylus or digital pen. These gestures can be used to perform various functions, like drawing, highlighting, or navigating through apps. The terms pen, digital pen, and digital stylus may be used interchangeably.

In accordance with embodiments of the present disclosure, at least one user device (i.e. the main device or the input device such as the digital stylus) should be able to access Artificial Intelligence (AI) tools, such as but not limited to large language model(s), Automatic Speech Recognition (ASR) service, Optical Character Recognition (OCR) service, and/or AI assistant(s)/agent(s). The AI tools can be accessed either from cloud services, or from local storage (i.e. on device), or from both cloud and local.

The systems and apparatuses disclosed herein comprise suitable modules and/or circuitries for executing various procedures. As those skilled in the art understand, a “module” is a term of explanation referring to a hardware structure such as a circuitry implemented using technologies such as electrical and/or optical technologies (and with more specific examples of semiconductors) for performing defined operations or processing. A “module” may alternatively refer to the combination of a hardware structure and a software structure, wherein the hardware structure may be implemented using technologies such as electrical and/or optical technologies (and with more specific examples of semiconductors) in a general manner for performing defined operations or processing according to the software structure in the form of a set of instructions stored in one or more non-transitory, computer-readable storage devices or media.

As will be described in more detail below, a module may be a part of a device, an apparatus, a system, and/or the like, wherein the module may be coupled to or integrated with other parts of the device, apparatus, or system such that the combination thereof forms the device, apparatus, or system. Alternatively, the module may be implemented as a standalone device or apparatus.

The module usually executes a procedure for performing a method. Herein, a procedure has a general meaning equivalent to that of a method. More specifically, a procedure is a defined method implemented using hardware components for processing data. A procedure may comprise or use one or more functions for processing data as designed. Herein, a function is a defined sub-procedure or sub-method for computing, calculating, or otherwise processing input data in a defined manner and generating or otherwise producing output data.

As those skilled in the art will appreciate, a procedure may be implemented as one or more software and/or firmware programs having necessary computer-executable code or instructions and stored in one or more non-transitory computer-readable storage devices or media which may be any volatile and/or non-volatile, non-removable or removable storage devices such as RAM, ROM, EEPROM, solid-state memory devices, hard disks, CDs, DVDs, flash memory devices, and/or the like. A module may read the computer-executable code from the storage devices and execute the computer-executable code to perform the procedure.

Alternatively, a procedure may be implemented as one or more hardware structures having necessary electrical and/or optical components, circuits, logic gates, integrated circuit (IC) chips, and/or the like.

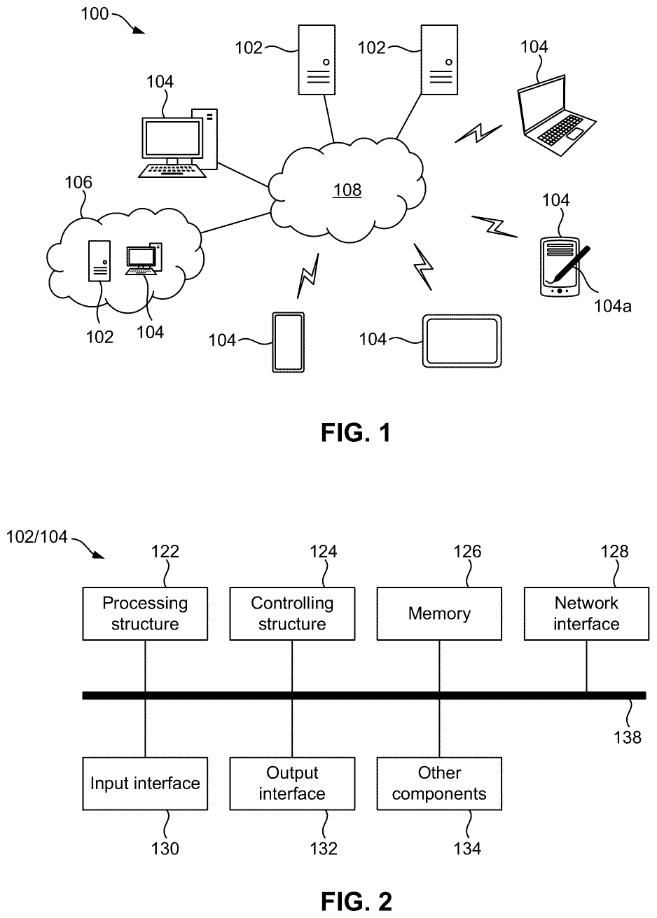

Turning now to FIG. 1, a computer network system is shown and is generally identified using reference numeral 100. As shown, the computer network system 100 comprises one or more server computers 102, a plurality of client computing devices 104, and one or more client computer systems 106 functionally interconnected by a network 108, such as the Internet, a local area network (LAN), a wide area network (WAN), a metropolitan area network (MAN), and/or the like, via suitable wired and wireless networking connections.

The server computers 102 may be computing devices designed specifically for use as a server, and/or general-purpose computing devices acting server computers while also being used by various users. Each server computer 102 may execute one or more server programs.

The client computing devices 104 may be portable and/or non-portable computing devices such as a tablet, touch screen, personal computer, smart phone, smart watch, smart glasses, a hybrid device, and/or the like. Each client computing device 104 may execute one or more client application programs which sometimes may be called “apps”. Each client computing device 104 may allow for web browsing over the network 108. The client computing devices 104 support user interaction, for example via one or more input devices such as a mouse, touchpad, touchscreen, digital stylus (pen), and/or user voice input, etc. The client computing devices 104 should also equip necessary sensors, computing units, and input/output units, such as CPU, storage disk, memory, Bluetooth, Wi-Fi, IMU sensors, pressure sensors on the screen or on the edge, microphone(s), camera(s), compacity-enable area (for touch-related interaction), display(s), vibration actuator(s), speaker(s), light(s), and button(s). A digital stylus or pen 104a can support both continuous ink printing and pen-tip interaction with the user device 104. The pen 104a may be equipped with various sensors, including but not limited to IMU sensors, pressure sensors (on the pen body and/or pen tip), etc. The pen 104a may also comprise various other hardware-related components, including but not limited to a microphone(s), compacity-enable area (for touch-related interaction), display(s), vibration actuator(s), speaker(s), light(s), button(s), or other sensors or motors for control and/or display.

The client computing device 104 and/or pen 104a should also be able to access AI tools, such as but not limited to a large language model, ASR service, OCR service, AI assistant(s)/agent(s) functionality, etc. The AI tools can be accessed either from cloud services, or from local (on device), or from both cloud and local. The computing device 104 and/or pen 104a may access such tools from a server 102 over the network 108.

Generally, the computing devices 102 and 104 comprise similar hardware structures such as hardware structure shown in FIG. 2. The pen 104a may also have a similar hardware structure such as hardware structure shown in FIG. 2. As shown in FIG. 2, the computing device hardware structure comprises a processing structure 122, a controlling structure 124, one or more non-transitory computer-readable memory or storage devices 126, a network interface 128, an input interface 130, and an output interface 132, functionally interconnected by a system bus 138. The computing device may also comprise other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also comprise one or more real-time processors, programmable logic controllers (PLCs), microcontroller units (MCUs), u-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case may be. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 102) may be implemented using other technologies such as analog technologies.

Referring back to FIG. 2, the controlling structure 124 comprises one or more controlling circuits, such as graphic controllers, input/output chipsets and the like, for coordinating operations of various hardware components and modules of the computing device.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The network interface 128 comprises one or more network modules for connecting to other computing devices or networks through the network 108 by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The input interface 130 of computing devices 102/104 comprises one or more input modules for one or more users to input data via, for example, touch-sensitive screen, touch-sensitive whiteboard, touch-pad, keyboards, computer mouse, trackball, microphone, scanners, cameras, buttons, and/or the like. The input interface 130 may be a physically integrated part of the computing device 102/104 (for example, the touch-pad of a laptop computer or the touch-sensitive screen of a tablet), or may be a device physically separate from, but functionally coupled to, other components of the computing device 102/104 (for example, a computer mouse). The input interface 130, in some implementations, may be integrated with a display output to form a touch-sensitive screen or touch-sensitive whiteboard. For a pen 104a, the input interface may similarly comprise one or more input modules for one or more users to input data via, for example, touch-and/or pressure-sensitive pen body, microphone, scanners, cameras, buttons, and/or the like.

The output interface 132 comprises one or more output modules for output data to a user. Examples of the output modules comprise displays (such as monitors, LCD displays, LED displays, projectors, and the like), speakers, printers, lights, virtual reality (VR) headsets, augmented reality (AR) goggles, and/or the like. The output interface 132 may be a physically integrated part of the computing device 102/104 (for example, the display of a laptop computer or tablet), or may be a device physically separate from but functionally coupled to other components of the computing device 102/104 (for example, the monitor of a desktop computer).

The computing device may also comprise other components 134 such as one or more positioning modules, temperature sensors, pressure sensors, barometers, inertial measurement unit (IMU), and/or the like.

The system bus 138 interconnects various components 122 to 134 enabling them to transmit and receive data and control signals to and from each other.

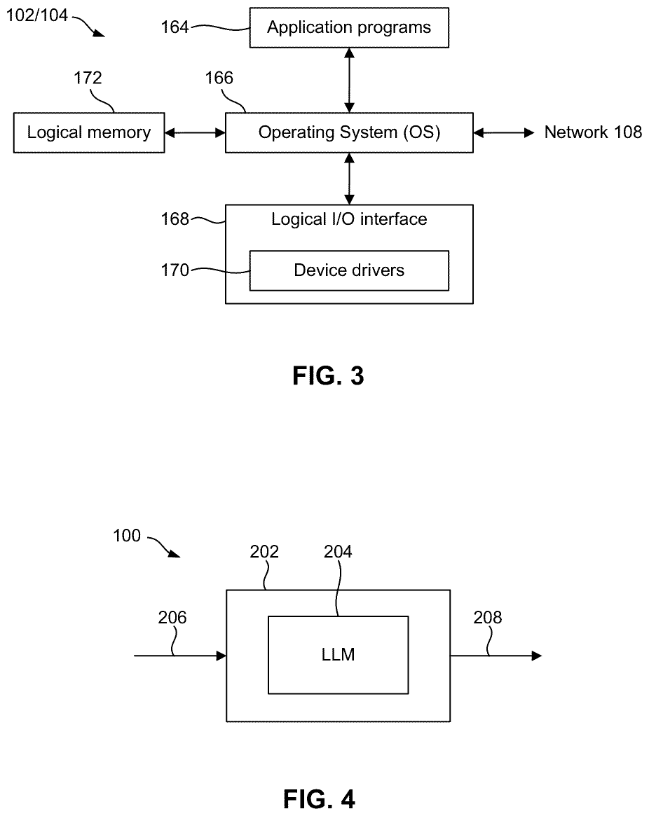

FIG. 3 shows a simplified software architecture of the computing device 102 or 104. The pen 104a may also have a similar software architecture. On the software side, the computing device comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 are executed by or run by the processing structure 122 for performing various tasks.

The operating system 166 manages various hardware components of the computing device 102 or 104 via the logical I/O interface 168, manages the logical memory 172, and manages and supports the application programs 164. The operating system 166 is also in communication with other computing devices (not shown) via the network 108 to allow application programs 164 to communicate with those running on other computing devices. As those skilled in the art will appreciate, the operating system 166 may be any suitable operating system such as MICROSOFT® WINDOWS® (MICROSOFT and WINDOWS are registered trademarks of the Microsoft Corp., Redmond, WA, USA), APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing devices 102 and 104 may all have the same operating system, or may have different operating systems.

The logical I/O interface 168 comprises one or more device drivers 170 for communicating with respective input and output interfaces 130 and 132 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 132).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

In a server computer 102, the one or more application programs 164 generally provide server functions for managing network communication with client computing devices 104 and facilitating collaboration between the server computer 102 and the client computing devices 104. Herein, the term “server” may refer to a server computer 102 from a hardware point of view or a logical server from a software point of view, depending on the context. Similarly, in a client computing device 104, the one or more application programs generally provide functionality for users of the client computing devices 104 and that communicate with the server computer 102.

As described above, the processing structure 122 is usually of no use without meaningful firmware and/or software. Similarly, while a computer system such as the computer network system 100 may have the potential to perform various tasks, it cannot perform any tasks and is of no use without meaningful firmware and/or software. As will be described in more detail later, the computer network system 100 described herein and the modules, circuitries, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

In some embodiments, the computer network system 100 executes an artificial intelligence (AI) engine (for example, in the form of one or more software programs). As shown in FIG. 4, the AI engine 202 comprises a model (such as a LLM 204, which is used as an example in the following description) for processing input 206 (also called “prompt”; for example, natural language input in the form of text, voice, images, and/or the like), recognizing and interpreting the input 206 for generating the output 208 in suitable forms as the response to the prompt 206. As those skilled in the art will appreciate, models such as LLMs are neural network models that learn the semantics and syntax of language by encoding (sub)words into vector representations.

Using LLMs as an example, LLMs use transformer models and are trained using massive datasets. Current LLMs such as Chat-GPT, GPT-4, LLaMA, and PaLM2 have proven to achieve state-of-the-art (SOTA) performance in various natural language processing (NLP) tasks.

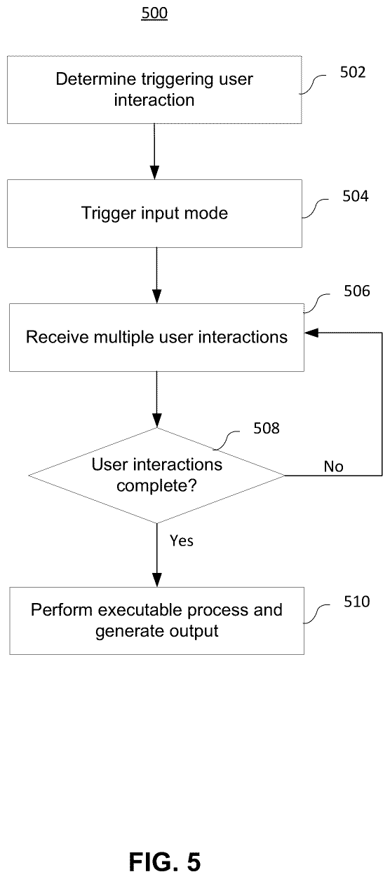

FIG. 5 is a method 500 for supporting multiple user interactions associated with content on a user interface. The method 500 is implemented by a user device, which may for example be a main device (e.g. a digital device as described above, such as a tablet) and/or an input device (e.g. an input device as described above, such as a pen). The main device displays content on a user interface thereon. The input device may be used to interact with the content on the main device. The main device may also directly support user interaction thereon.

The method 500 comprises determining, by a user device, that a triggering user interaction has occurred (502). The method 500 further comprises triggering, based on the triggering user interaction, a multi-operation input mode (504) which allows a user to interact with content on a user interface. For example, the triggering user interaction may be a trigger gesture. The trigger gesture may be provided on a user interface of the main device, for example. The main device can receive the triggering user interaction via the inputs received on the user interface. Alternatively, the input device, such as the pen, can receive the triggering user interaction based on interaction with the user interface of the main device. Additionally or alternatively, the triggering user interaction may involve a user physically pressing a button or other input on the pen. In some embodiments, as described below, the triggering user interaction may be one of: applying pressure to a tip of a digital stylus against the user interface; performing a corner swipe on the user interface; hovering the digital stylus above the user interface followed by tapping the tip of the digital stylus against the user interface; touching the user interface with the tip of the digital stylus and a user finger simultaneously; and applying pressure to a body of the digital stylus.

The multi-operation input mode supports multiple user interactions with content on the user interface, including multiple different types of interactions. The method 500 comprises receiving, during the input mode, multiple user interactions associated with the content on the user interface (506). The multiple user interactions may be received for example as inputs at the main device. Additionally or alternatively, the multiple user interactions may be received as inputs at the input device, and/or interactions between the input device and the main device (e.g. based on data from one or more sensors in the input device that are indicative of how the input device is interacting with the main device). Of course, the input mode may also support a single user interaction with content on the user interface to trigger a task/inquiry described below, however particular advantages and user benefits are realized by supporting multiple user interactions. In some embodiments, the multiple user interactions associated with the content comprise one or more types of user interactions selected from: a gesture made on the user interface, text written on the user interface, a symbol drawn on the user interface, and user voice input. The multiple user interactions associated with the content may comprise a user interaction provided by a writing instrument such as a digital stylus/pen. The multiple user interactions may comprise a sequence of user interactions. For example, the multiple user interactions may comprise: a gesture made on the user interface followed by a text annotation; a gesture made on the user interface followed by user voice input; a gesture made on the user interface followed by a symbol drawn on the user interface; etc.

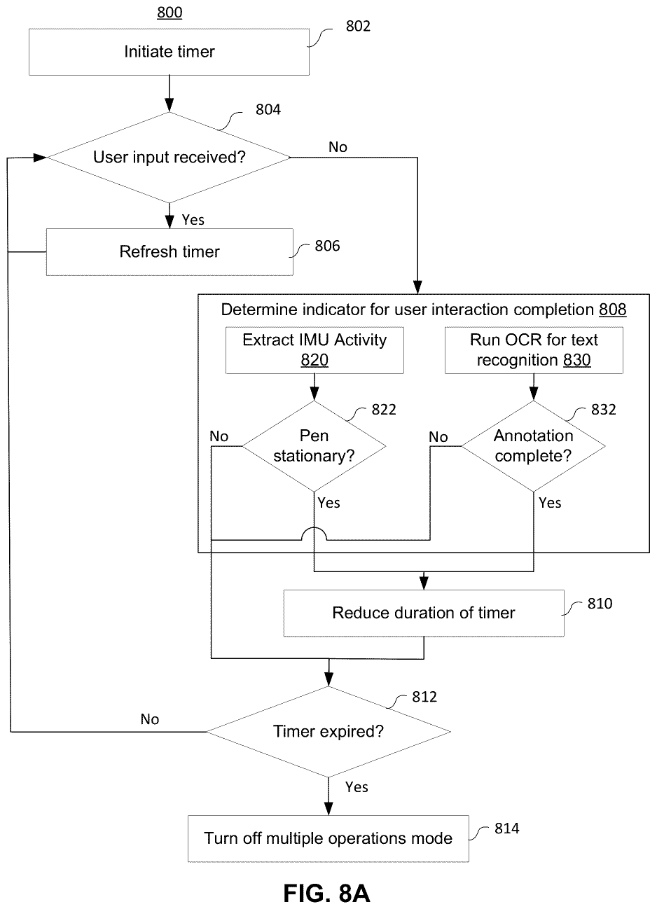

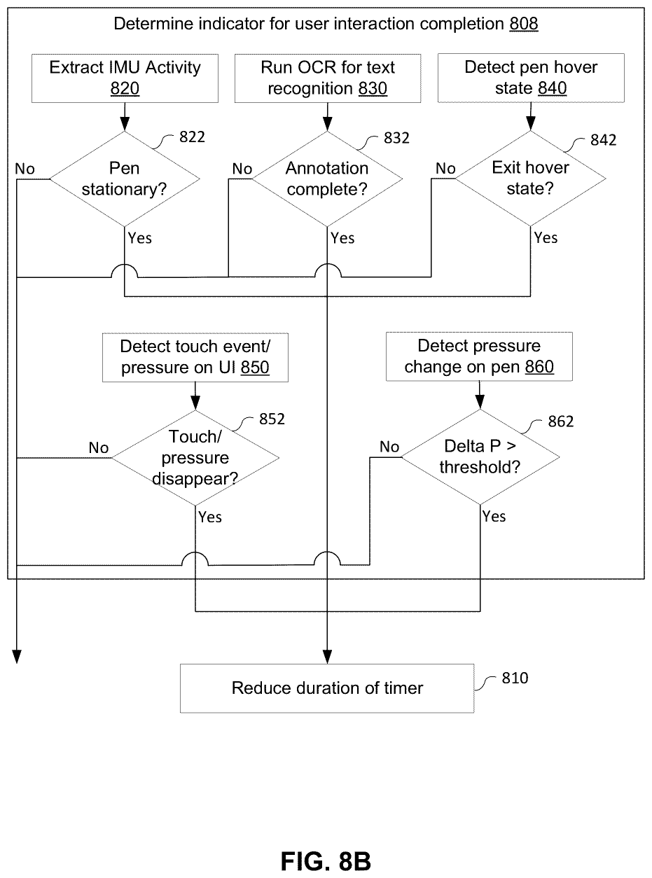

A determination is made as to whether the user interactions with the content on the user interface are completed (508). In some embodiments, determining whether the user interactions with the content are completed may comprise utilizing a dynamic timer mechanism. In some embodiments, the determination may comprise initiating a timer when the input mode is triggered, refreshing the timer when a user interaction associated with the content is received, and determining that the multiple user interactions associated with the content are completed when the timer expires. In some embodiments, the dynamic timer may further comprise determining presence of an indicator that the user has completed interactions with the content, and reducing a duration of the timer based on the presence of the indicator. In some embodiments, reducing the duration of the timer comprises causing expiry of the timer based on the presence of the indicator. The indicator that the user has completed interactions with the content can be determined based on contextual information (e.g. semantically complete text annotations) and/or features of the user device(s) (e.g. pen posture, touch area on screen, pressure on pen body, etc.). Exemplary methods of determining that the user interactions with the content are completed are described in more detail with reference to FIGS. 8A and 8B.

If the user interactions with the content on the user interface are not completed (No at 508), the method continues to receive the multiple user interactions associated with the content (506). If the user interactions with the content are completed (Yes at 508), the multi-operation input mode is exited and an executable process is performed and an output is generated (510) for display in the user interface based on the multiple user interactions received during the multi-operation input mode. The executable process performed is not a predetermined result of the multiple user interactions. That is, the executable process is itself based on the multiple user interactions, as opposed to being a pre-defined process in response to a pre-defined command.

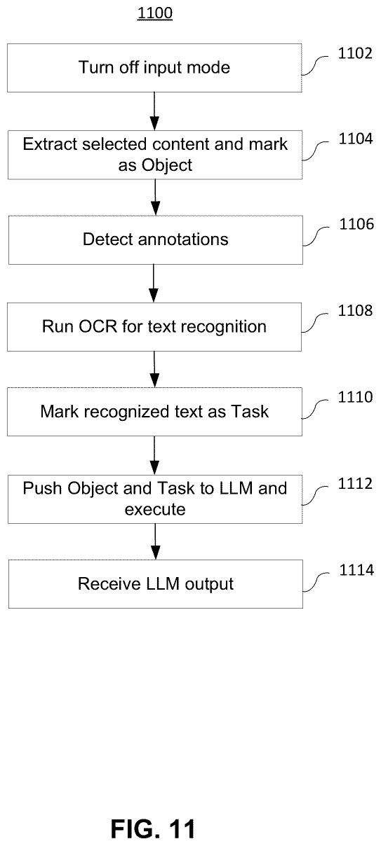

In some embodiments, performing the executable process comprises generating a prompt to an artificial intelligence model based on the multiple user interactions, providing the prompt to the artificial intelligence model, and receiving the output from the artificial intelligence model. In some embodiments, generating the prompt comprises determining, based on the multiple user interactions, an object of the content that the user has interacted with, and a task to be executed. In some embodiments, the method further comprises performing optical character recognition on a text annotation to determine text written on the user interface, and the text written on the user interface is the task to be executed. In some embodiments, the method further comprises performing automatic speech recognition on user voice input to determine text corresponding to the user voice input, and the text corresponding to the user voice input is the task to be executed. In some embodiments, the method further comprises determining a predefined function associated with the symbol drawn on the user interface, and the predefined function is the task to be executed. In some embodiments, the method comprises receiving, after the multiple user interactions associated with the content are completed, a further user interaction to trigger the AI inquiry process and generate the prompt to the artificial intelligence model; and generating the prompt in response to the further user interaction. Exemplary further user interactions to trigger the AI inquiry process are described in more detail with reference to FIGS. 11 to 16. Moreover, the output displayed in the user interface, which is generated based on the response from the artificial intelligence model, may further comprise an input interface to allow a user to input a further inquiry in response to the initial output, which may be used to further prompt the artificial intelligence model. Accordingly, a user may be able to continue to refine the inquiry to the artificial intelligence model.

In other embodiments, generating the output comprises determining, based on the multiple user interactions, an object of the content that the user has interacted with and generating the output as an option menu associated with the object. For example, a traditional drop down menu option can be presented based on an object of the content that the user has interacted with. As an example, if the user is interacting with text, a traditional drop down menu showing cut, copy, paste, etc., functionality may be presented.

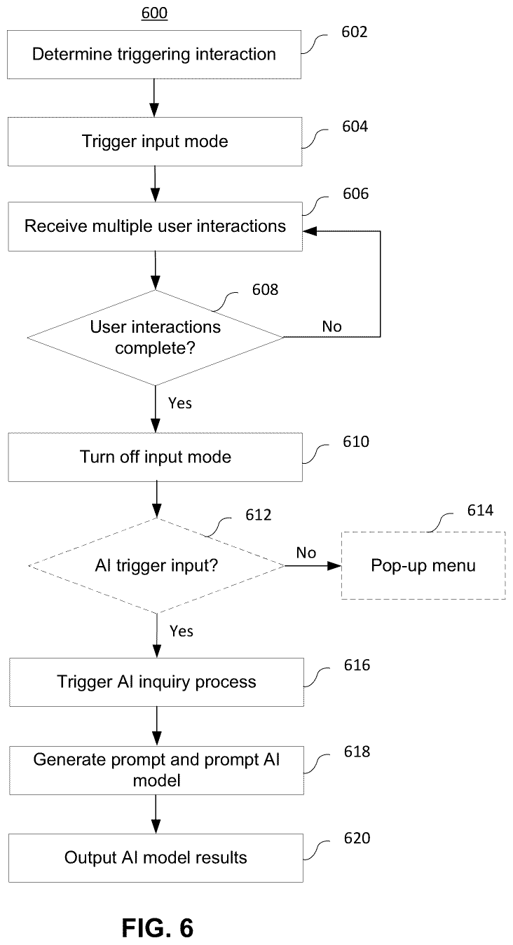

FIG. 6 is a further method 600 for supporting multiple user interactions associated with content on a user interface. The method 600 is an embodiment of the method 500 described with reference to FIG. 5.

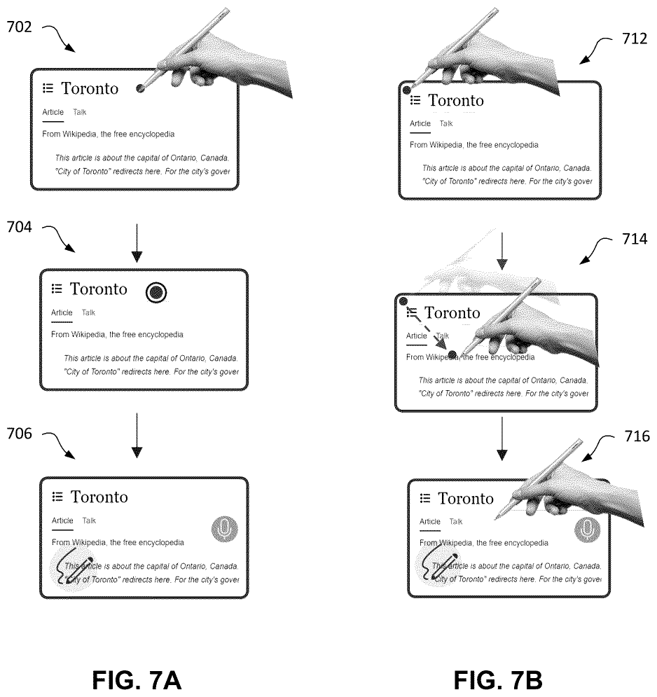

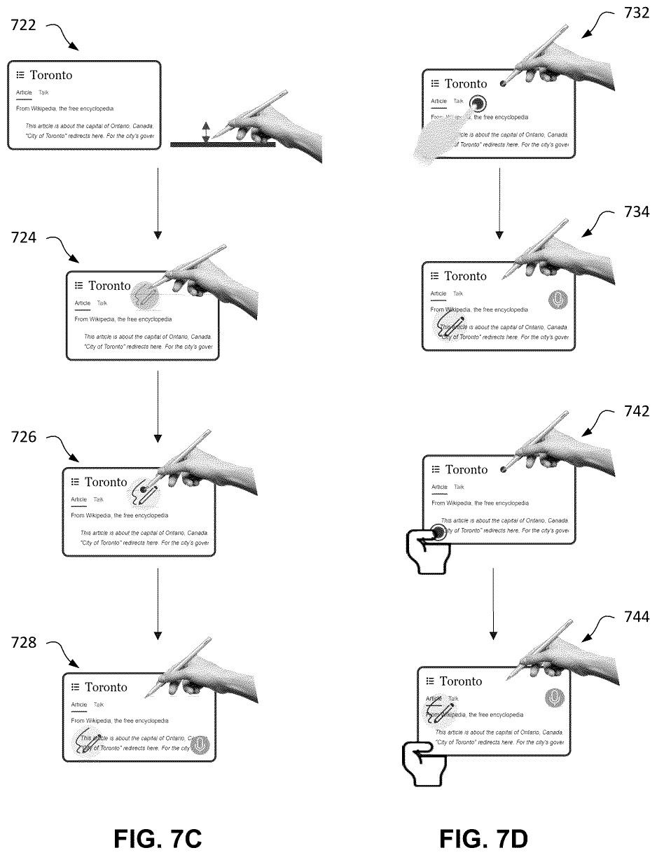

A triggering user interaction is received (602). The triggering user interaction is a user interaction with a user interface on the digital device and/or input instrument (e.g. hardware on the pen). Examples of trigger interactions are described in more detail below with reference to FIGS. 7A-D. In response to the determination of the triggering user interaction, a multi-operation input mode is triggered (604), which supports multiple user interactions/operations associated with content on a user interface. As described herein, the input mode supports multiple user interactions with the content, including multi-modal user interactions. For example, the user can draw continuously using a pen and/or speak to a built-in microphone of the main device and/or the pen.

Multiple user interactions associated with the content on the user interface are received in the input mode (606). In some embodiments, the multiple user interactions may comprise, for example, a first drawing to select content, followed by a user writing text annotations, drawing symbol(s), and/or articulating a voice command. A determination is made if the user interactions with the content are complete (608). Methods of determining that the multiple user interactions associated with the content are completed are described in more detail with reference to FIGS. 8A and 8B. If it is determined that the user interactions with the content are not completed (No at 608), the method continues to receive the multiple user interactions (606). If it is determined that the user interactions with the content are completed (Yes) at 608, the input mode (i.e. that supports multiple user interactions associated with the content) is turned off (610).

An executable process and appropriate output may be generated for the user in response to the multiple user interactions. In some embodiments, an inquiry process to an AI model/engine may be automatically triggered. In other embodiments, further user input is required to trigger the AI process, which provides flexibility for users to choose whether to trigger the AI inquiry process or be presented with a conventional menu-based interaction. For example, after selecting a content using pen drawing, if a user chooses to do nothing then a conventional popup menu may be displayed (e.g. presenting conventional operations, such as copy, search, translate etc.). An object of the content that the user has interacted with may be determined so that the option menu presented is appropriate to the content (e.g. a different menu option if text is selected vs. an image). However, a user could also perform a dedicated interaction such as a pen/hand gesture following the input mode to proactively trigger the AI agent. When the AI inquiry process is triggered, the multiple user interactions are consolidated as one inquiry and sent to an AI model.

Accordingly, in some embodiments a determination may be made as whether an AI trigger interaction/input is made (612). If there is no AI trigger interaction (No at 612), and a trigger interaction is required to initiate the AI inquiry process, then a conventional pop-up option menu associated with the content is displayed (614). If an AI trigger interaction is received (Yes at 612), or if the AI inquiry process is automatically initiated after completion of the multiple operations mode, the AI inquiry process is triggered (616). A graphical user interface may be presented on the user interface of user device when the AI inquiry process is triggered.

For the AI inquiry process, a prompt is generated, which is used to prompt the AI model (618). Generating the prompt may comprise determining, based on the multiple user interactions, an object of the content that the user has interacted with, and a task to be executed. Methods and examples of generating prompts to the AI model and corresponding outputs are described further herein with reference to FIGS. 11 to 20. The output from the AI model results is received and output for display to the user (620).

FIGS. 7A-D are examples of triggering user interactions used to trigger a multiple operations input mode. While these interactions/gestures with the user device(s) provide simple techniques to trigger the multiple operations input mode that may be preferred by users, it will be appreciated that these gestures are simply examples and that other techniques may be implemented to trigger the input mode, including using a user's finger or a computer mouse to perform the gesture instead of a pen, and/or user inputs with hardware (e.g. a button) on the main device and/or the pen. For example, a user may squeeze or otherwise apply pressure to a body of the pen to trigger the multiple operations input mode. Accordingly, it will be appreciated that FIGS. 7A-D represent non-limiting examples of a triggering user interaction with a user device to trigger a multiple operations input mode.

FIG. 7A depicts an example of triggering a multiple operations input mode by applying pressure to the pen tip against the user interface. In this method, the user touches the screen with the pen, then imposes a heavy press on the screen. Pressure changes on the pen tip (ΔP) must be higher than a threshold. The press may be within a certain timeframe (Δt) and within a certain moving distance (Δd is lower than a threshold), meaning the pen is held still. Once the gesture is confirmed, the multiple-operation input mode turns on (mode switched). When the multiple-operations mode is turned on, a canvas may be applied in the user interface to support writing input, a microphone of the main device and/or pen may be turned on to support voice input, etc. There could be UI feedback(s) to indicate that the mode is on. Other optional feedbacks may include a microphone-on sound effect, pen vibration, etc.

Referring to FIG. 7A, the interaction flow shows a user making a first touch of the user interface with the pen (702), followed by a heavy press of the pen onto the user interface (704). The gesture is confirmed as a trigger gesture and the multiple operations input mode turns on. (706). The user may then perform multiple interactions with the content, including writing on the user interface, speaking into a microphone, etc.

FIG. 7B depicts an example of triggering a multiple operations input mode by performing a corner swipe (in this case, a top left corner swipe). The user uses the pen to touch either the top left corner of an application window (application level) or the top left of the screen (at system level) (712). The user then swipes diagonally (714). The gesture is confirmed as a trigger gesture and the multiple operations input mode turns on (716). When the multiple-operations mode is turned on, a canvas may be applied in the user interface to support writing input, a microphone of the main device and/or pen may be turned on to support voice input, etc. Similarly, there could be UI feedback(s) to indicate that the mode is on. Other optional feedbacks may include a microphone-on sound effect, pen vibration, etc.

FIG. 7C depicts an example of triggering a multiple operations input mode by performing a pen hover then tap. In this embodiment, the user hovers the pen and dwells over the screen (722). A floating toggle button would appear (724). The user taps on the button (726). The gesture is confirmed as a trigger gesture and the multiple operations input mode turns on (728).

There are several criteria that may be used to differentiate this gesture from others. For example: (1) The hover must be lower than certain height, which means it is not a hold and rest posture; (2) Contents on the screen must stay static after pen hover detected (not a scrolling gesture); (3) The area/object the pen is hovering over has no hover state, e.g. hovering above texts, blank space (not links or other objects that are already enable a hover-state).

Once the hover state is confirmed and after a preset time threshold, a floating icon may appear. Then the user may use the pen tip to tap the floating icon (e.g. a UI button) and activate the input mode. The button transitions to an active state, indicating the multiple operations input mode is on. When the multiple-operations input mode is turned on, a canvas may be applied in the user interface to support writing input, a microphone of the main device and/or pen may be turned on to support voice input, etc. Other optional feedbacks may include a microphone-on sound effect, pen vibration, etc.

FIG. 7D depicts two example of triggering a multiple operations input mode by performing a pen plus finger touch. In one example, the main device is supported and a user uses a finger to touch on the user interface; in the other example, the user may be supporting the main device with their hand, and use their thumb to touch on the user interface.

The user uses one finger to touch on empty space or non-clickable area of the user interface, and the pen tip touches the user interface (732, 742). The gesture is confirmed as a trigger gesture and the multiple operations input mode turns on (734, 744). When the multiple-operations input mode is turned on, a canvas may be applied in the user interface to support writing input, a microphone of the main device and/or pen may be turned on to support voice input, etc. Similarly, there could be UI feedback(s) to indicate that the multiple operations mode is on. Other optional feedbacks may include a microphone-on sound effect, pen vibration, etc.

This interaction must be distinguishable from other hand/pen gestures (not scrolling, zoom in/out, or navigation gesture), for example by confirming that contents on the screen keep static after any touches are detected and no touch points move within a preset pixel range within a preset time frame.

As described above, after triggering the input mode, multiple user interactions associated with content on the user interface are determined/detected. The multiple user interactions can include multi-modal interactions, including a gesture on the user interface, text written on the user interface, a symbol drawn on the user interface, user voice input, etc. When the multiple user interactions are completed, the input mode is exited and an output is generated (e.g. by triggering an AI inquiry, presenting a conventional options menu, etc.). Accordingly, it is necessary to determine when the user has completed the multiple interactions associated with the content. It is preferable that the determination is performed shortly after the user has completed the multiple interactions, so that a user is not waiting for a reply to their interactions, which would diminish the user's experience. Further, in preferred embodiments, a user may not be required to actively provide an input that the user interactions are complete, but could simply stop interacting with the content and the completion of the user interactions be automatically determined.

FIGS. 8A and 8B are example methods of determining that the multiple user interactions associated with the content are completed. In this example method, a variety of features are evaluated to determine if the user has completed interacting with the content, and a dynamic timer is used to maintain or exit the multiple operations input mode.

In the method 800, a timer is initiated when the multiple operations input mode is turned on (802). The timer may for example be a pre-defined amount of time that starts counting down, and when the timer expires, it is determined that the multiple user interactions associated with the content are completed. The pre-defined amount of time should be long enough so that the user has time to interact with the content before the timer expires, but not so long that a user has stopped interacting with the content but is required to wait a prolonged period of time before receiving an output in response to their interactions.

In the method 800, a determination is made as to whether user input is received (804). The user inputs can include, for example, pen input strokes; pen strokes recognized as text or functional symbols; user voice transcribed to ASR results, etc. If a user input is received (Yes at 804), the user is still interacting with the content and thus the timer is refreshed (806), and the method continues to determine whether user input is received (804). If no user input is received (No at 804), the timer continues to count down and a determination may be made as to whether there is a strong indicator that the user has completed interactions with the content (808).

In particular, a strong indicator that the user has completed interactions with the content can be determined by evaluating contextual information of the inputs, and/or by evaluating features of the user device(s) (e.g. the main device and/or the pen). If a strong indicator for user interaction completion is present, this means that there is a high likelihood that the user has completed their interaction with the content. When it is determined that there is a strong indicator that the user has completed interactions with the content, the method 800 reduces a duration of the timer (810). For example: the timer may count down faster; the timer may be set to a new, shorter amount of time; the timer may be caused to expire; etc. The advantage of reducing the duration of the timer when an indicator that the user interaction is complete is to improve the user experience, so that a user would wait less time before receiving an output in response to their interaction(s) with the content.

A determination is made if the timer is expired (812). If the timer is not expired (No at 812), the method returns to evaluating if user input is received (804). If the timer is expired (Yes at 812), the multiple operations input mode is turned off (814), and the process proceeds to generating an output based on the multiple user interactions.

As explained above, a variety of features can be extracted and evaluated to determine if there is a strong indicator that the user has completed interacting with the content. The features can be extracted and evaluated in parallel, and if any one of the features is present, then it can be determined that a strong indicator is present.

Depending on the capabilities and configuration of the user device, different features may be evaluated. In FIG. 8A, two features are evaluated for whether or not a strong indicator of user interaction completion is present. The features evaluated in FIG. 8A are (1) whether or not the pen is in a stationary state, and (2) whether or not text annotations on the user interface are semantically complete (i.e. has the user written a complete sentence or a phrase).

To determine if the pen is in a stationary state, Inertial Measurement Unit (IMU) activity of the pen is extracted (820) and a determination is made as to whether the pen is stationary based on the extracted IMU activity (822) (i.e. no IMU variations for a duration exceeding a threshold). If the pen is stationary (Yes at 822), there is a strong indicator that the user interaction with the content is completed. If the pen is not stationary (No at 822), a strong indicator for completion of user interaction cannot be inferred.

To determine whether or not text annotations on the user interface are semantically complete, Optical Character Recognition (OCR) is performed on the annotation to perform text recognition (830), a determination is made based on the text annotation whether the annotation is semantically complete (832). The text annotation may be passed to an AI model to determine if the text annotation is semantically complete. If the text annotation is semantically complete (Yes at 832), there is a strong indicator that the user interaction with the content is completed. If the text annotation is not semantically complete (No at 822), a strong indicator for completion of user interaction cannot be inferred.

It will be appreciated that other types of features can be evaluated to determine strong indicators as to whether the user has completed interaction with the content. Moreover, depending on the hardware capabilities of the input device and/or main device, some features may not be a strong indicator of user interaction completion. For example, if a user device has a microphone, evaluating whether a pen is hovering above a user interface is not necessarily a strong indicator of user interaction completion because a user could simply be hovering the pen while they speak into the microphone. Alternatively, if the user devices do not support audio input, then hovering the pen could be a strong indicator of user interaction completion because it is the main way that the user interacts with the main device. The strong indicators evaluated in FIG. 8A have been found to be accurate indicators of user interaction completion regardless of whether the input device and the main device have user voice inputs (i.e. a microphone).

FIG. 8B shows a determination as to whether there is a strong indicator that the user has completed interactions with the content (808) based on additional features that may be used in the method 800. The determination 808 in FIG. 8B may be particularly used in cases where the input device and the main device do not allow for voice inputs, and thus more features relating to writing-only behavior can be considered.

The determination at 808 still involves determining whether or not the pen is in a stationary state, and whether or not text annotations on the user interface are semantically complete, as described with reference to FIG. 8A. In FIG. 8B, the further features evaluated are: (1) exit of a pen hover state, i.e. a vertical distance (Δh) between pen tip and the surface of screen exceeding a threshold; (2) disappearance of touch area and/or pressure of palm or finger(s) resting on the screen; and (3) the reduction of pressure applied on pen body between writing and current state (Δp) passes a threshold (based on the assumption that the pressure applied on pen body for holding-only is lower than for writing).

To determine if the pen has exited a hover state, hover state data including a height or vertical distance between the pen tip and the user interface is determined (840) and a determination is made as to whether the pen has exited a hover state (842) (i.e. the vertical distance exceeds a threshold). If the pen has exited a hover state (Yes at 842), there is a strong indicator that the user interaction with the content is completed. If the pen is still hovering above the user interface (No at 842), a strong indicator for completion of user interaction cannot be inferred.

Touch event and/or pressure data on the user interface (850) may be used to determine if the touch area and/or pressure applied to the user interface has disappeared (852). When the touch event and/or pressure applied to the user interface has disappeared (Yes at 852), it is an indicator that the user interaction with the content is completed. If the touch event and/or pressure applied to the user interface is still present (No at 852), an indicator for completion of user interaction cannot be inferred.

Changes in pressure applied to the pen may be used to determine if there is a reduction of pressure applied to the pen (860) and a determination is made as to whether a reduction in the pressure applied to the pen body exceeds a threshold (862). If the reduction in the pressure applied to the pen body exceeds a threshold (Yes at 862), it is an indicator that the user interaction with the content is completed. If the reduction in the pressure applied to the pen body does not exceed a threshold (No at 862), an indicator for completion of user interaction cannot be inferred.

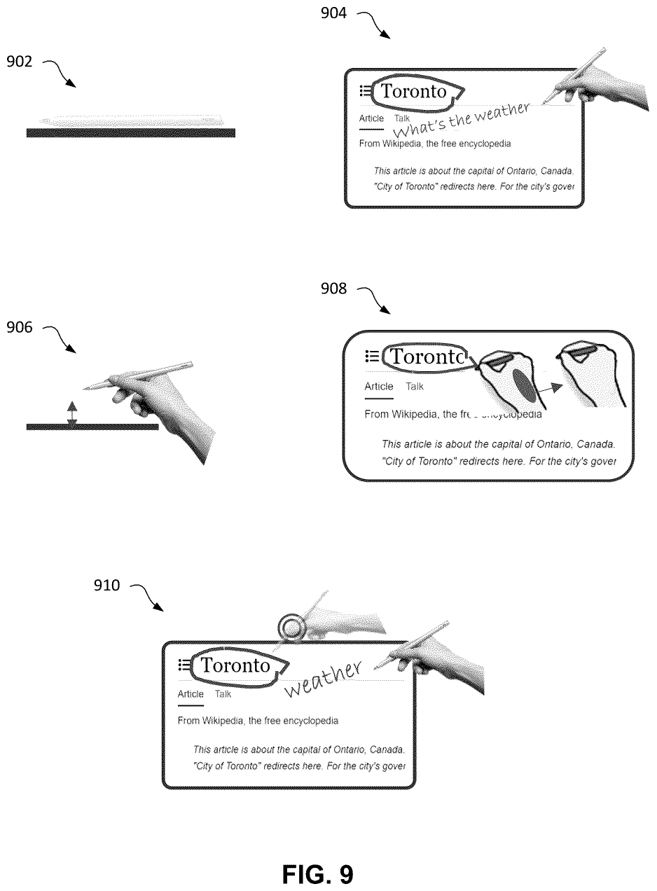

FIG. 9 shows representations of examples of indicators that the user has completed the multiple user interactions. For example, determining that the pen is in a stationary state is represented at 902. Determining that the text annotation is semantically complete is represented at 904. Determining that the pen has exited a hover state is represented at 906. Determining a disappearance of a touch area and/or pressure of palm or finger(s) resting on the screen is represented at 908. Determining a reduction of pressure applied to the pen is represented at 910.

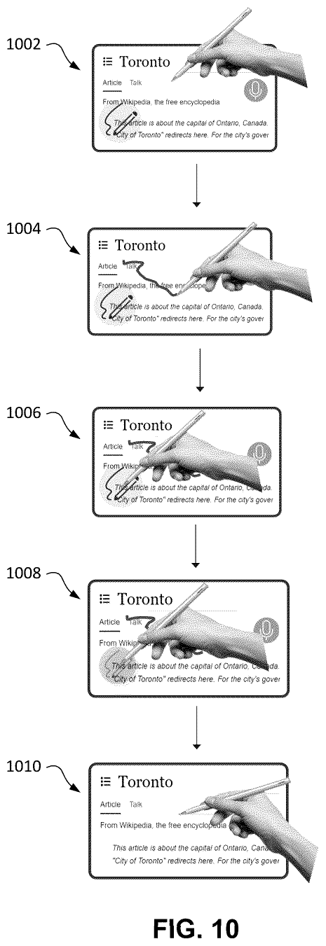

In addition to the use of a dynamic timer that is set and refreshed during the input mode as described with reference to the method 800, there may also be an exit mechanism for a user to exit the input mode, for example in case the user is in the middle of performing sequential operations but wants to undo them. It may also be possible to manually exit the input mode by clicking the input mode icon without waiting for the end of timer. FIG. 10 shows a representation of an example of how a user can manually exit the input mode.

At 1002, the multiple operations input mode is on, and a corresponding input mode icon may be presented on the user interface. At 1004, the user draws a line, however, the user is not satisfied with the line. At 1006, within a time interval (i.e. before the timer ends), the user clicks the mode icon. At 1008, the mode has been turned off. At 1010, the icon is dismissed and all inputs are dismissed.

As has been described above, once it is determined that the user has completed interactions with the content (e.g. based on the expiry of the dynamic timer described with reference to FIGS. 8A and 8B), an executable process is performed and the user inputs are integrated to generate a single inquiry, which can be a prompt to an AI model to provide a response/output to the inquiry. Depending on what kinds of inputs the user has provided when interacting with the content during the input mode, the detailed operations of the work flow would be different. FIGS. 11 to 16 provide three examples of generating a prompt to the AI model based on multimodal inputs, namely: (1) pen selection gestures and text annotations; (2) pen selection gestures and voice input; and (3) pen selection gestures and semantically-meaningful symbols. It will be appreciated that these examples of combined inputs are non-limiting and that other combinations of inputs may be provided as the user interacts with the content.

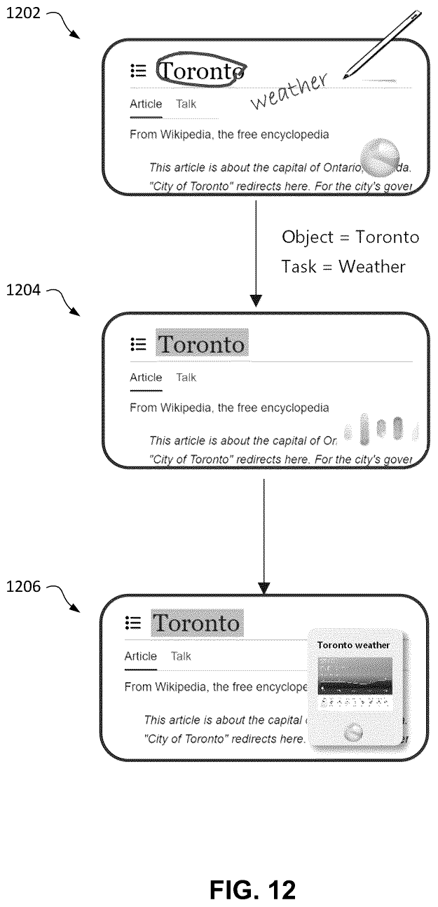

FIG. 11 is an example of a method 1100 of generating a prompt to an artificial intelligence model based on multiple user interactions. In this method, the user interactions with the content comprised pen selection gestures and text annotations. FIG. 12 shows a corresponding example representation of multiple user interactions associated with the content and a corresponding output.

The method 1100 is initiated after the multiple operations input mode is turned off (1102). Selected content from the associated user interactions (specifically, the pen selection gesture) is extracted, and marked as the “Object” (1104). The “object” is the subject the selection gesture is referring to. Selection gestures may include but are not limited to a circle, line, and scribble. For example, with reference to FIG. 12, as shown in the user interface 1202 the user has circled “Toronto” using the pen. Accordingly, the Object in this case would be “Toronto”.

Annotations are detected on the user interface (1106). Text recognition is performed by running OCR on the annotations (1108). The recognized text is marked as the “Task” (1110). The ‘task” is the action the user wants the software to execute. For example, with reference to FIG. 12, as shown in the user interface 1202 the user has written “weather” next to the selected content. Accordingly, the Task in this case would be “weather”.

A prompt is generated from the Object and Task, which is pushed to the AI model (e.g. an LLM) to execute (1112). As shown in FIG. 12, a GUI representing an AI agent may be presented on the user interface 1204 while it is processing the query. During this processing, optionally, the intelligent system could present different GUIs to indicate its processing status. The output from the LLM is received (1114), and displayed on the user interface, as for example shown in the user interface 1206 shown in FIG. 12. The output may also be provided with an input interface which allows a user to input a further inquiry to the AI model.

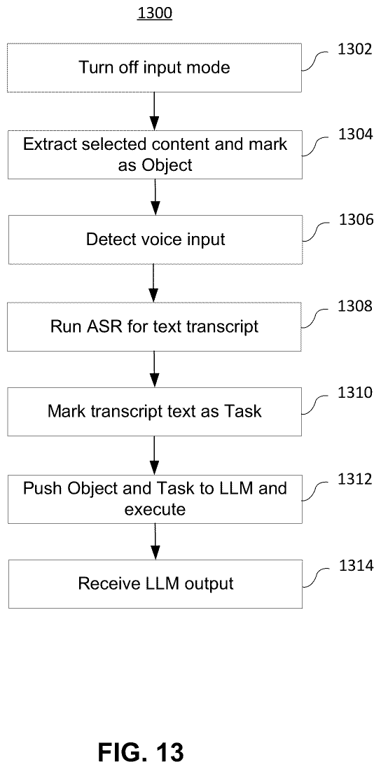

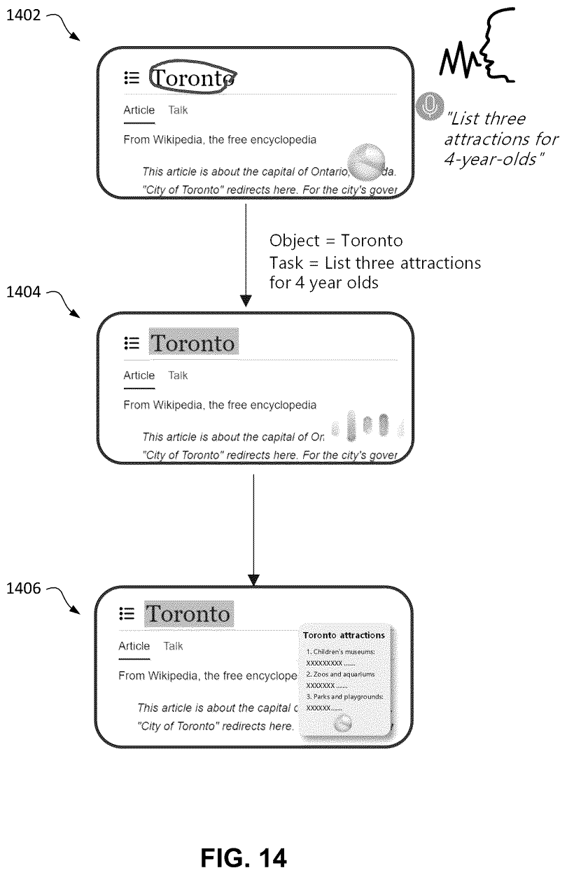

FIG. 13 is another example of a method of generating a prompt to an artificial intelligence model based on multiple user interactions. In this method, the user interactions with the content comprised pen selection gestures and user voice input. FIG. 14 shows a corresponding example representation of multiple user interactions associated with the content and a corresponding output.

The method 1300 is initiated after the multiple operations input mode is turned off (1302). Selected content from the associated user interactions (specifically, the pen selection gesture) is extracted, and marked as the “Object” (1304). The “object” is the subject the selection gesture is referring to. Selection gestures may include but are not limited to a circle, line, and scribble. For example, with reference to FIG. 14, as shown in the user interface 1402 the user has circled “Toronto” using the pen. Accordingly, the Object in this case would be “Toronto”.

A voice input is detected (1306), for example via a microphone on the user device. The voice input/recording is transcribed to generate a text transcript by running an ASR service (1308). The recognized text is marked as the “Task” (1310). The ‘task” is the action the user wants the software to execute. For example, with reference to FIG. 14, as shown in the user interface 1402 the user has asked “list three attractions for 4-year-olds” after selecting the content. Accordingly, the Task in this case would be “list three attractions for 4-year-olds”.

A prompt is generated from the Object and Task, which is pushed to the AI model (e.g. an LLM) to execute (1312). As shown in FIG. 14, a GUI representing an AI agent may be presented on the user interface 1404 while it is processing the query. During this processing, optionally, the intelligent system could present different GUIs to indicate its processing status. The output from the LLM is received (1314), and displayed on the user interface, as for example shown in the user interface 1406 shown in FIG. 14. The output may also be provided with an input interface which allows a user to input a further inquiry to the AI model.

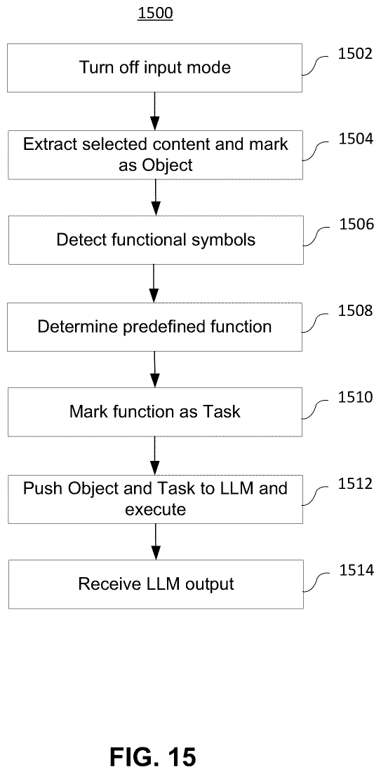

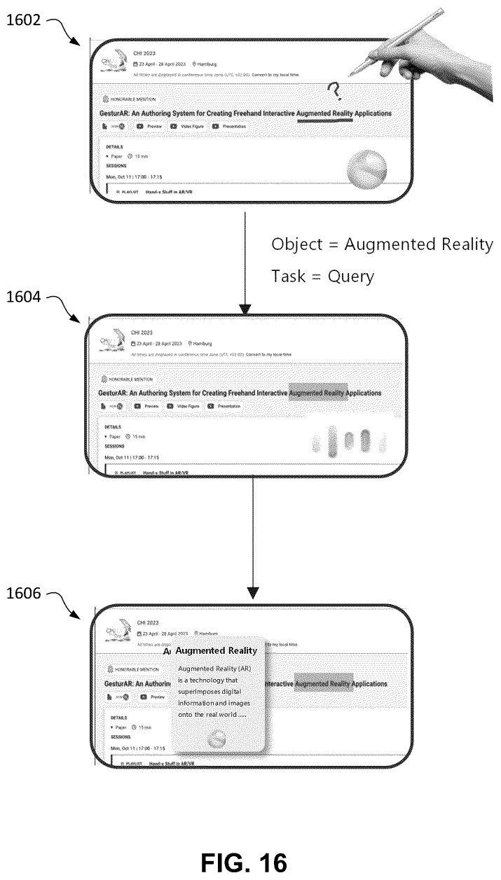

FIG. 15 is another example of a method 1500 of generating a prompt to an artificial intelligence model based on multiple user interactions. In this method, the user interactions with the content comprised pen selection gestures and semantically meaningful symbols. FIG. 16 shows a corresponding example representation of multiple user interactions associated with the content and a corresponding output.

The method 1500 is initiated after the multiple operations input mode is turned off (1502). Selected content from the associated user interactions (specifically, the pen selection gesture) is extracted, and marked as the “Object” (1504). The “object” is the subject the selection gesture is referring to. Selection gestures may include but are not limited to a circle, line, and scribble. For example, with reference to FIG. 16, as shown in the user interface 1602 the user has underlined “Augmented Reality” using the pen. Accordingly, the Object in this case would be “Augmented Reality”.

Semantically meaningful symbol(s) are detected on the user interface (1506). For example, symbols with pre-defined functions may include: a circle, line, or scribble, to select content; a question mark (“?”), to ask to explain content; brace(s) (“{}”), to ask to provide a summary of the content; a star or asterisk (“*”), to favorite content; etc. The system detects any functional symbols and identifies the predefined function that the symbol correlates to (1508). The identified function is marked as the “task” (1510). The ‘task” is the action the user wants the software to execute. For example, with reference to FIG. 16, as shown in the user interface 1602 the user has drawn a question mark, so the task is a query.

A prompt is generated from the Object and Task, which is pushed to the AI model (e.g. an LLM) to execute (1512). As shown in FIG. 16, a GUI representing an AI agent may be presented on the user interface 1604 while it is processing the query. During this processing, optionally, the intelligent system could present different GUIs to indicate its processing status. The output from the LLM is received (1514), and displayed on the user interface, as for example shown in the user interface 1606 shown in FIG. 16. The output may also be provided with an input interface which allows a user to input a further inquiry to the AI model.

In each of the methods 1100, 1300, and 1500 described above that provide examples of generating a prompt to the AI model based on multimodal inputs, selected content is extracted from the associated user interactions (specifically, the pen selection gesture), and marked as the “Object”. In some embodiments, determining the object of the content that the user has interacted with comprises performing intention-based object selection. Performing intention-based object selection comprises analyzing the multiple user interactions to define an initial selection, and modifying the initial selection to an adjusted selection that is a semantically complete object.

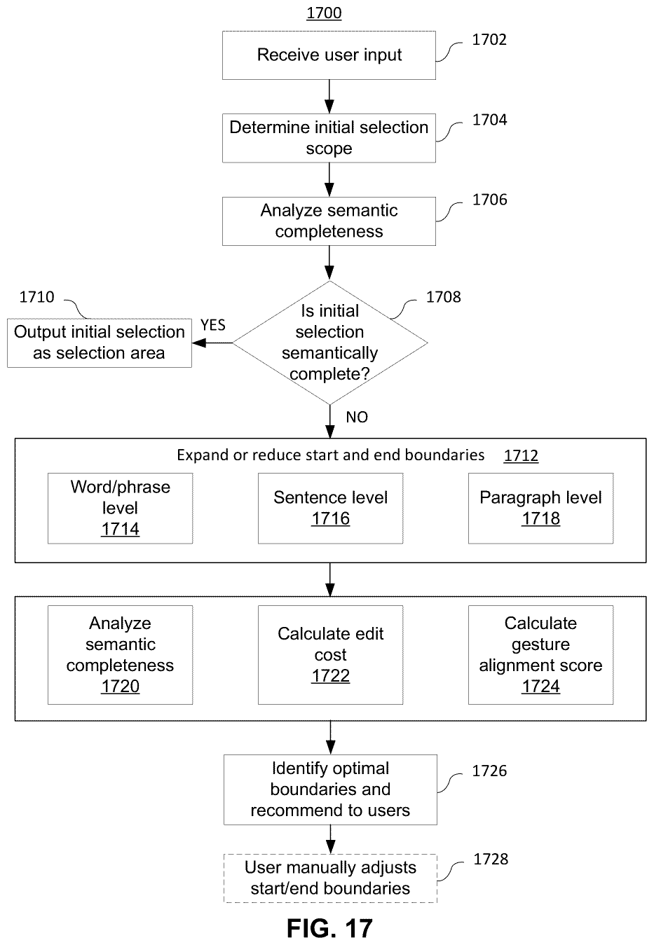

FIG. 17 is a method 1700 of performing intention-based object selection. User interactions (specifically, the pen selection gesture) are received as input during the multiple operations input mode (1702). After the multiple operations input mode is turned off, an initial selection scope is determined from the associated user interactions that were received (1704). That is, based on the user's pen gestures (such as circles, lines, or scribbles), the system determines an initial selection scope of content on the user interface. The pen gesture is analyzed to map its coordinates onto the text content in the user interface. For instance, if a user draws a circle around a group of words, the system identifies the text within the circle's boundary as the initial selection. Then, the initial selection of content may be modified/adjusted (e.g. expanded or reduced in scope) as follows.

The initial selection is analyzed for semantic completeness (1706), and a determination is made as to whether the scope of the initial selection is semantically complete (1708). Many implementations can be used to determine semantic completeness, spanning rule-based approaches, statistical modeling, syntactic and semantic parsing, and supervised machine learning. Rule-based approaches rely on sentence boundary disambiguation rules: treating periods, question marks, and exclamation points as terminators unless they occur in known abbreviations or numeric contexts, and requiring that the following token begins with a capital letter. Syntactic parsing approaches run a constituency or dependency parser over the candidate span. One can check whether it yields a valid parse tree containing at least one clausal structure (e.g., an S node) that spans the entire text. Incomplete sentences often produce partial parses or leave unparsed fragments, which can be detected via parser confidence scores or by checking for unconnected subtrees. Supervised machine learning algorithms, such as “Complete Sentence Detection,” train transformer classifiers on labeled speech transcripts, achieving over 90% accuracy in distinguishing complete from incomplete sentences. Features include token sequences, part-of-speech tags, dependency arcs, and punctuation patterns, often fed into fine-tuned BERT or ROBERTa models. When the initial selection is determined to be semantically complete (YES at 1708), the initial selection is extracted as the selection area and marked as “Object” (1710). When the initial selection is determined to be semantically incomplete (NO at 1708), the method comprises expanding or reducing the start and/or end boundaries of the initial selection to determine/identify a semantically complete object (1712). Expanding or reducing the start and/or end boundaries of the initial selection may be performed at a word/phrase level (1714), a sentence level (1716), and/or a paragraph level (1718).

For word/phrase level expansion, if the selected content is a partial word group or an incomplete phrase, the system/method adds words at the start or end to form a complete phrase. For example, if the user selects “the big” from “the big house”, the system expands it to “the big house” by adding “house” at the end.

For sentence level expansion, when the selected content is a partial sentence, the system/method expands the start and end boundaries to the nearest complete sentence. For example, if the user selects “Because it” from “Because it rained, we stayed home”, the system expands the selection to the entire sentence.

For paragraph level expansion, if the selected content is a partial paragraph, the system/method expands the start and end boundaries to the nearest complete paragraph.

For word/phrase level reduction, if the selected content includes extra words or phrases at the start or end that are not necessary for semantic completeness, the system/method removes them. For instance, if the user selects “in the morning. the dog runs at the park” and “in the morning” does not form a complete sentence, the system reduces the selection to “the dog runs at the park”.

For phrase level reduction, when the selected content includes extra phrases, the system/method trims the start or end boundaries to remove the unnecessary phrases. For instance, if the user selects “in the morning. the dog runs at the park” and “in the morning” does not form a complete sentence, the system reduces the selection to “the dog runs at the park”.

For sentence level reduction, if the selected content includes extra sentences, the system/method removes the non-essential sentences from the start or end of the selection. For example, if the user selects two sentences where one is just a supplementary note, the system reduces the selection to the main sentence.

For paragraph level reduction, in case the selected content includes extra paragraphs, the system removes the non-relevant paragraphs from the start or end of the selection.

The decision to expand or reduce the initial selection and by what amount may comprise determining potential adjustment selections comprising possible expansions and/or reductions of the text content, filtering out semantically incomplete expansions or reductions, and optimizing one or more parameters to determine the optimal semantically complete expansion or reduction. Users may also pre-select preferences for the system to determine potential adjustment selections, such as a user selecting that the system should always perform sentence-level editing, and therefore only sentence-level expansions and reductions are considered.

The method comprises analyzing semantic completeness of potential adjustment selections that have been expanded or reduced relative to the initial selection (1720). Again, the potential adjustment selections may be determined based on user preferences. Potential adjustment selections that are not semantically complete can be filtered out, and only those that are semantically complete are further analyzed.

For each of the remaining potential adjustment selections (i.e. that are semantically complete), an edit cost (1722) and gesture alignment score (1724) may be calculated.

The editing cost (1722) is determined by the number of words, sentences, or paragraphs to be added or removed. A word-level cost may be equal to the number of words added or removed. For example, if expanding a selection requires adding 3 words, the word-level cost is 3. A phrase-level cost may be calculated based on the number of words in the phrase being added or removed. A more complex phrase with more words will have a higher cost. A sentence-level cost may be determined by the number of sentences added or removed. Each sentence may have a base cost, and additional costs may be added based on the length and complexity of the sentence. A paragraph-level cost may be calculated based on the number of paragraphs added or removed. Paragraphs are considered more significant units, so the cost may be set relatively higher compared to lower-level units.

The gesture alignment score (1724) is calculated for each scenario of potential adjustment selections. This gesture alignment score is calculated based on the spatial overlap between the user's pen gesture bounding box and the bounding box of the adjusted text selection. If the adjusted selection has a large overlap with the user's pen gesture, the gesture alignment score is high. For example, if the user makes a circular gesture around a word, and an expansion scenario results in a selection that closely matches the circle, the gesture alignment score for that scenario will be high.

Optimal boundaries for the adjusted selection are determined (1726). The system/method ranks the scenarios of the semantically-complete potential adjustment selections based on the editing cost and the gesture alignment score. As one non-limiting example, the potential adjustment selections may be ranked based on editing cost in ascending order, where a potential adjusted selection with a lowest editing cost is ranked higher. In case of a tie in editing costs, the potential adjusted selection with the highest gesture alignment score is selected. This ensures that the final selection is not only semantically complete but also closely aligned with the user's pen gesture.

After the optimal potential adjusted selection is identified, the system recommends it to the user in the display of the user interface. The user may have the option to accept the recommended selection or further modify the selection area by manually adjusting the starting and ending scope (1728). This provides flexibility and allows the user to fine-tune the selection according to their specific needs/objectives of the selection.

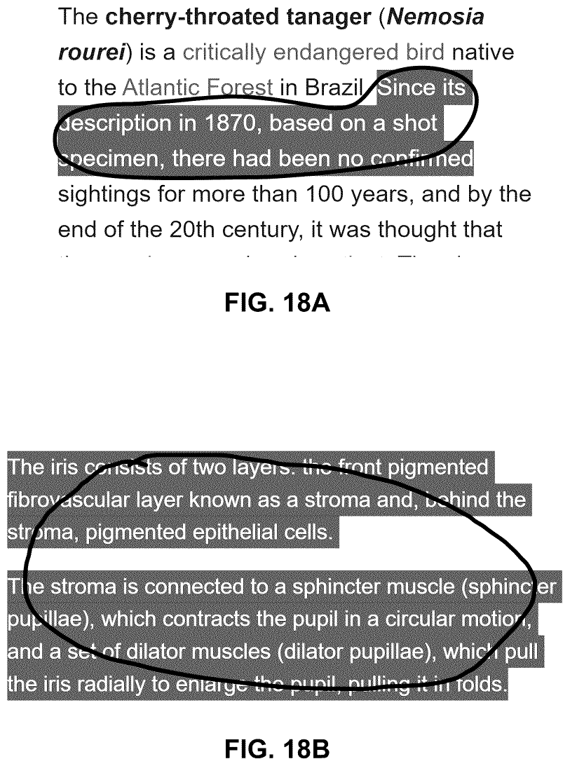

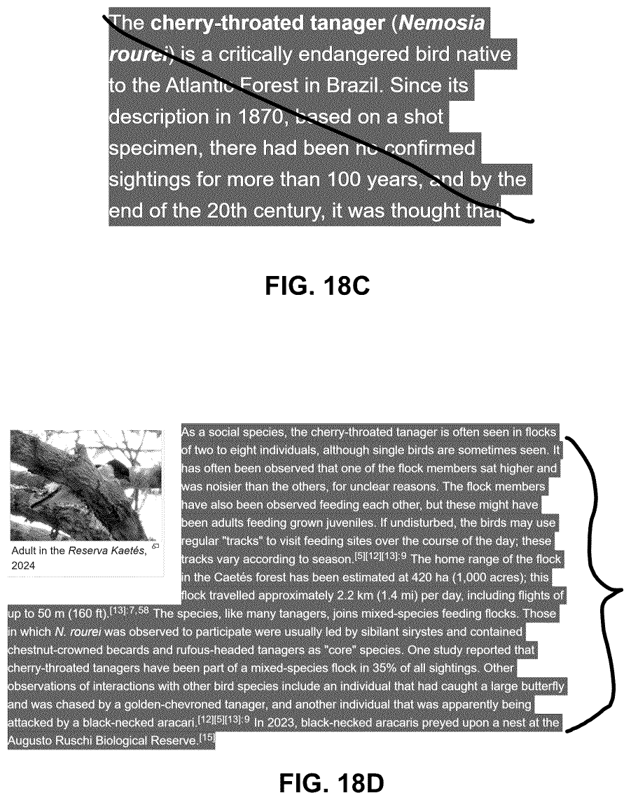

FIGS. 18A-D show examples of intention-based object selection. FIG. 18A shows an example of a user's pen selection gesture as a circle around text content, and the highlighted text representing the adjusted selection, which is a semantically complete text based on the user's pen selection gesture. FIG. 18B shows a similar example. FIG. 18C shows an example of a user's pen selection gesture as a line across text content, and the highlighted text representing the adjusted selection of semantically complete text. FIG. 18D shows an example of a user's pen selection gesture as a bracket beside text content, and the highlighted text representing the adjusted selection of semantically complete text.

As has been described above, in some embodiments, the AI agent functionality that involves generating an appropriate inquiry based on the user interactions and prompting an AI model to produce an output is triggered automatically once the user interactions with the content are completed and the input mode is turned off. However, in other embodiments, as has also been described above, the user may provide a further user interaction/input in order to trigger the AI agent functionality.

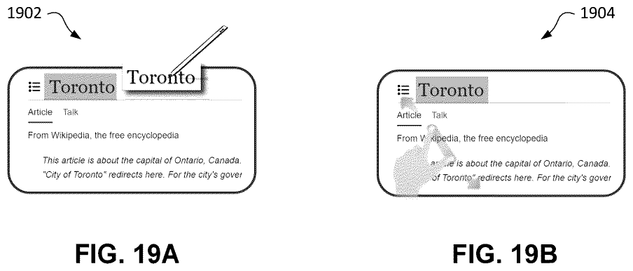

FIGS. 19A and 19B show two example representations of triggering an AI agent, namely: (1) using a pen to hold and drag the selected content (as shown in FIG. 19A with respect to user interface 1902); and (2) pinching outwards using two fingers after the content is selected (as shown in FIG. 19B with respect to user interface 1904). It will be appreciated that these examples of gestures to trigger the AI agent are non-limiting and that other gestures may be implemented instead.

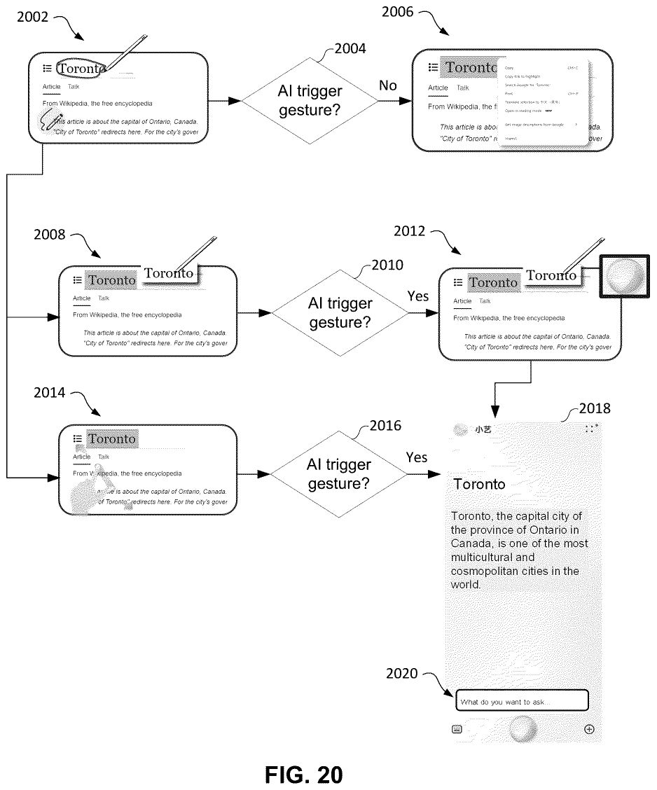

FIG. 20 shows a representation of different possible flows for generating an output based on whether an AI trigger interaction/gesture is input. As shown in FIG. 20, once the multiple operations input mode is turned off, the selected content (e.g. “Toronto” in user interface 2002) is extracted and marked as the “object”. Then, depending on whether a further interaction corresponding to an AI trigger gesture is detected or not, different flows could be triggered.

If there are no predefined interactions/gestures detected to trigger the AI agent interaction (e.g. No at 2004), a conventional popup menu is presented, as shown in user interface 2006.

However, if the user holds and drags the content (e.g. as shown in user interface 2008), an AI trigger gesture is detected (Yes at 2010) and the AI agent icon will pop up and show UI effects (as shown in user interface 2012). The user can drag the content on top of the AI agent. The agent window will open, the AI agent processes the inquiry and provides an answer based on the inference of the “object” (as shown at 2018). Similarly, if the user pinches outwards (e.g. as shown in user interface 2014), an AI trigger gesture is detected (Yes at 2016), the agent window will open, the AI agent processes the inquiry and provides an answer based on the inference of the “object” (as shown at 2018). As also described above, in addition to the answer received from the AI model, the output 2018 may also comprise an input interface, in this case input box 2020, which allows a user to input a further inquiry to the AI model.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the above-described embodiments and/or features thereof may be customized, separated, and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A computerized method comprising:
determining, by a user device, that a triggering user interaction has occurred;
triggering a multi-operation input mode for a user to interact with content on a user interface;
receiving, during the input mode, multiple user interactions associated with the content on the user interface;
determining that the multiple user interactions associated with the content are completed, and exiting the multi-operation input mode; and
based on the multiple user interactions during the input mode, performing an executable process and generating an output for display in the user interface.

2. The computerized method of claim 1, wherein performing the executable process comprises:
generating a prompt to an artificial intelligence model based on the multiple user interactions;
providing the prompt to the artificial intelligence model; and
receiving the output from the artificial intelligence model.

3. The computerized method of claim 2, wherein generating the prompt comprises determining, based on the multiple user interactions, an object of the content that the user has interacted with, and a task to be executed.

4. The computerized method of claim 3, wherein determining the object of the content that the user has interacted with comprises performing intention-based object selection.

5. The computerized method of claim 4, wherein performing intention-based object selection comprises:
analyzing the multiple user interactions to define an initial selection; and
modifying the initial selection to a semantically complete object.

6. The computerized method of claim 5, wherein modifying the initial selection comprises at least one of:
adjusting a start boundary of the initial selection to an adjusted start boundary of an adjusted selection, wherein the adjusted start boundary is a valid semantic start; and
adjusting an end boundary of the initial selection to an adjusted end boundary of the adjusted selection, wherein the adjusted end boundary is a valid semantic end; and
wherein the adjusted selection defined by the adjusted start boundary and/or the adjusted end boundary is semantically complete.

7. The computerized method of claim 6, wherein the adjusted selection is determined by:
calculating an editing cost for each of one or more potential adjusted selections based on the number of sematic objects added or removed; and
measuring a gesture alignment score for each of the one or more potential adjusted selections based on a spatial overlap between a gesture bounding box and an adjusted selection bounding box;
wherein the adjusted selection is one of the of one or more potential selections with a lowest editing cost and a highest gesture alignment score.

8. The computerized method of claim 7, wherein the one or more potential adjusted selections are determined based on user preferences.

9. The computerized method of claim 7, wherein the user further adjusts the adjusted selection manually.

10. The computerized method of claim 3, the multiple user interactions associated with the content comprise one or more types of user interactions selected from: a gesture made on the user interface, a text annotation on the user interface, a symbol drawn on the user interface, and user voice input.

11. The computerized method of claim 10, wherein the multiple user interactions comprise one or more of:
the gesture made on the user interface followed by the text annotation;
the gesture made on the user interface followed by the user voice input; and
the gesture made on the user interface followed by the symbol drawn on the user interface.

12. The computerized method of claim 11, further comprising one or more of:
performing optical character recognition on the text annotation to determine text written on the user interface, wherein the text written on the user interface is the task to be executed;
performing automatic speech recognition on the user voice input to determine text corresponding to the user voice input, wherein the text corresponding to the user voice input is the task to be executed; and
determining a predefined function associated with the symbol drawn on the user interface, wherein the predefined function is the task to be executed.

13. The computerized method of claim 2, further comprising:
receiving, after the multiple user interactions associated with the content are completed, a further user interaction to prompt the artificial intelligence model; and
generating the prompt in response to the further user interaction.

14. The computerized method of claim 2, wherein the output generated for display in the user interface further comprises an input interface for a user to input a further inquiry for prompting the artificial intelligence model.

15. The computerized method of claim 1, wherein determining that the multiple user interactions associated with the content are completed comprises:
initiating a timer when the input mode is triggered;
refreshing the timer when a user interaction associated with the content is received; and
determining that the multiple user interactions associated with the content are completed when the timer expires.

16. The computerized method of claim 15, further comprising:
determining presence of an indicator that the user has completed interactions with the content; and
reducing a duration of the timer based on the presence of the indicator.

17. The computerized method of claim 16, wherein reducing the duration of the timer comprises causing expiry of the timer based on the presence of the indicator.

18. The computerized method of claim 17, wherein the indicator that the user has completed interactions with the content comprises one or more of:
a digital stylus used to interact with the content is in a stationary state;
text annotations written on the user interface are semantically complete;
a tip of the digital stylus exits a hover state above the user interface;
a touch area and/or pressure applied to the user interface disappears; and
a pressure applied to a body of the digital stylus reduces beyond a threshold between a writing state and a current state.

19. The computerized method of claim 1, wherein the executable process performed is not a predetermined result of the multiple user interactions.

20. The computerized method of claim 1, wherein generating the output comprises:
determining, based on the multiple user interactions, an object of the content that the user has interacted with; and
generating the output as an option menu associated with the object.

21. The computerized method of claim 1, wherein the multiple user interactions associated with the content comprise a user interaction using a digital stylus.

22. The computerized method of claim 1, wherein the triggering user interaction with the user device is one of:
applying pressure to a tip of a digital stylus against the user interface;
performing a corner swipe on the user interface;
hovering the digital stylus above the user interface followed by tapping the tip of the digital stylus against the user interface;
touching the user interface with the tip of the digital stylus and a user finger simultaneously; and
applying pressure to a body of the digital stylus.

23. One or more processors functionally connected to one or more memories storing instructions, and the one or more processors is configured to execute the instructions to perform actions comprising:
determining, by a user device, that a triggering user interaction has occurred;
triggering a multi-operation input mode for a user to interact with content on a user interface;
receiving, during the input mode, multiple user interactions associated with the content on the user interface;
determining that the multiple user interactions associated with the content are completed, and exiting the multi-operation input mode; and
based on the multiple user interactions during the input mode, performing an executable process and generating an output for display in the user interface.

24. One or more non-transitory, computer-readable storage media comprising computer-executable instructions, wherein the instructions, when executed, cause one or more processors to perform actions comprising:
determining, by a user device, that a triggering user interaction has occurred;
triggering a multi-operation input mode for a user to interact with content on a user interface;
receiving, during the input mode, multiple user interactions associated with the content on the user interface;
determining that the multiple user interactions associated with the content are completed, and exiting the multi-operation input mode; and
based on the multiple user interactions during the input mode, performing an executable process and generating an output for display in the user interface.
